(19) United States
(12) Patent Application Publication
(10) Pub. No.: US 2008/0144808 A1
(43) Pub. Date: Jun. 19, 2008

(54) CIRCUIT FOR ADJUSTING IMPEDANCE MISMATCH AND METHOD THEREFOR

(76) Inventor: Patrick D. Goodrich, Phoenix, AZ (US)

Correspondence Address: WEISS & MOY PC, 4204 NORTH BROWN AVENUE, SCOTTSDALE, AZ, 85251, US

(21) Appl. No.: 11/612,602

(22) Filed: Dec. 19, 2006

(51) Int. Cl. H04M 9/08

(52) U.S. Cl. 379/406.01

(57) ABSTRACT

A circuit that connects into a telephone line to correct an impedance mismatch between two pieces of equipment, which eliminates the echo that results from an impedance mismatch. The circuit is reversible and adjustable to match a wide range of impedance differences, to minimize or eliminate echo at its source on a telephone line. The circuit performs this function efficiently and at a low cost, thereby eliminating the need to add expensive echo canceling devices after the fact. The circuit does not require power. It is completely passive and exhibits very low insertion loss. It is compatible with all of the signaling that occurs on an analog telephone line

### FIELD OF THE INVENTION

The present invention relates generally to telephony equipment, and more specifically, to a device that connects into a telephone line to correct an impedance mismatch between two pieces of equipment, which eliminates the echo that results from an impedance mismatch.

### BACKGROUND OF THE INVENTION

Because more and more telephone calls are being routed through digital media including voice over internet protocol (VoIP) and cell phones, the time delays inherent from digitizing and undigitizing the voice signals (i.e. into packets) make any analog impedance mismatches within the whole connection noticeably audible as echo. Previously, without digital delays, most echoes were masked because it occurred almost instantaneously and was therefore perceived as sidetone. Impedance mismatches occur frequently between equipment connected by 2-wire analog telephone lines such as a VoIP box connected to a PBX system.

Whenever there is an impedance mismatch in a transmission line, it creates echoes in both directions. It is called near-end echo when the mismatch point is nearby and far-end echo when the mismatch is at the far end of the line or a distant point.

Even the standards for telephone line impedance changed in the United States in the 1980s because of deregulation of the telephone companies. The telephone company had standardized on 900 ohms, but the audio and broadcast industries had standardized on 600 ohms. Newcomers to the telephone industry built equipment with 600 ohm impedance because of the availability of parts. The effects of the impedance mismatches were minimally perceptible at the time, and were ignored.

In other countries standard line impedances vary widely. With globalization, analog equipment provided from various manufacturers often provides unintended impedance mismatches from the very start. There needs to be a way to reduce or eliminate the now audible echo in these situations.

Telephone installers often bear the brunt of the problem after a telephone system is installed, the user, or more often the user's customers; complain about the echo they hear when calling the user. The installers try to correct the impedance mismatch between pieces of equipment from various manufacturers and usually without any help from the manufacturers. The only currently available device to try to correct the problem is called an echo canceller which is very expensive and requires one for each telephone line affected. The price of echo cancellers can exceed the cost of a complete telephone system being installed.

While a few telephone equipment manufacturers provide a simple 600/900 ohm switch in equipment such as PBX line cards, most do not. Because most new telephone equipment is primarily digital, the design engineers apply digital techniques, such as digital signal processors (DSPs) to find and try to cancel out the echo when it is encountered. Sometimes the digital echo cancellers are swamped by the signal level or complexity of the echo signals and cannot clean up the voice signal enough to be pleasing to the users.

Since an analog telephone line carries a wide variety of signals, including ringing, loop current, caller ID and dial tones as well as voice, using a simple impedance transformer to convert impedances is not possible without significant support circuitry. Impedance transformers tend to be loosely coupled and inefficient, especially when being run “wet” (with DC current running through them in addition to an audio signal), which is often required on telephone lines.

The figure of merit of the impedance matching is called return-loss. Even what are considered to be reasonably good impedance transformers can, themselves, introduce a return loss of 14 decibels (dB) which is equivalent to an impedance mismatch of 600 to 900 ohms. This means that the simple inclusion of such a transformer into a telephone circuit can cause an echo, in this case an echo which is 14 dB less than the original audio signal.

With the cost of echo cancellers and the ineffectiveness of impedance transformers, telephone installers are left without an affordable solution in systems with distracting echo due to analog impedance mismatches.

Therefore, it would be desirable to provide a device and method to overcome the above problem. The device would connect into a telephone line to correct an impedance mismatch between two pieces of equipment, which eliminates the echo that results from an impedance mismatch.

### SUMMARY OF THE INVENTION

In accordance with one embodiment of the present invention, a circuit that connects into a telephone line to correct an impedance mismatch between two pieces of equipment to eliminate an echo that results from the impedance mismatch is disclosed. The circuit has an autotransformer wherein a winding of the autotransformer is separated into a primary and a pair of secondary windings. A capacitive element is coupled to the primary winding.

In accordance with another embodiment of the present invention, a circuit that connects into a telephone line to correct an impedance mismatch between two pieces of equipment to eliminate an echo that results from the impedance mismatch is disclosed. The circuit has an autotransformer wherein a winding is separated into a primary and a pair of secondary windings. A capacitive element is coupled in series to the primary winding. A switching element is coupled to the primary winding and the secondary windings.

In accordance with another embodiment of the present invention, a circuit that connects into a telephone line to correct an impedance mismatch between two pieces of equipment to eliminate an echo that results from the impedance mismatch is disclosed. The circuit has an autotransformer wherein a winding is separated into a primary and a pair of secondary windings. A capacitive element is coupled in series to the primary winding. A switching element is coupled to the primary winding and the secondary windings. A variable resistive element is coupled in series to the primary winding.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings, wherein like reference numerals and symbols represent like elements.

FIG. 1 is a simplified electrical schematic depicting a prior art impedance transformer is used to convert line impedance.

FIG. 2 is a simplified electrical schematic depicting an autotransformer installed in a power line.

FIG. 3 is a simplified electrical schematic depicting an autotransformer with a blocking capacitor connected into a telephone line to transform the impedance.

FIG. 4 is a simplified electrical schematic depicting an autotransformer with a blocking capacitor and secondary windings connected into a telephone line to transform the impedance.

FIG. 5 is a table showing circuit values for a 600Q to 900Q converter.

FIG. 6 is a simplified electrical schematic depicting an autotransformer connected into a telephone line that transforms the impedance and does not short out the loop current and does not imbalance the line.

### DESCRIPTION OF PREFERRED EMBODIMENT

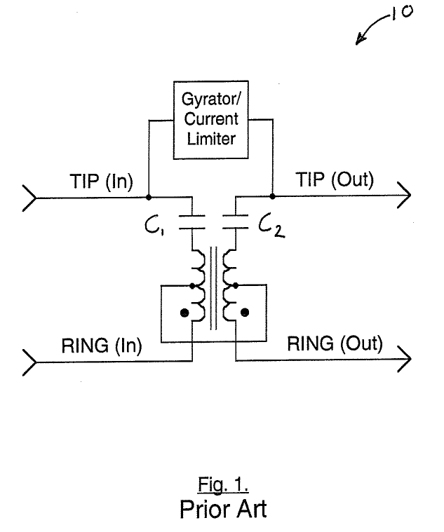

Referring to FIG. 1, a prior art simple impedance transformer 10 is shown. The impedance transformer 10 is used to convert line impedance. Because of the low impedances involved, the capacitors C1 and C2 required are either too small, which incurs significant signal loss, or too large and create an unacceptable ring load to the telephone line. There is no effective compromise, so the impedance transformer 10 causes as much of a problem as it seeks to cure. If the impedance transformer 10 cannot transform impedances inversely in opposite directions, it simply creates another impedance mismatch into the system.

Referring to FIG. 2, autotransformers 20 have been used widely in power systems to efficiently boost or drop voltage a small amount. Autotransformers 20 are extremely efficient because only a small portion of the power is driven through the transformer, the rest is conducted through a small portion of the windings. This also makes the autotransformer 20 small and inexpensive as compared to an isolating transformer with its separate primary and secondary windings.

Autotransformers have not been widely used in telephone circuits, with few exceptions such as in Stiefel's Telephone Station Repeater, U.S. Pat. No. 4,112,262, and then only within the telephone equipment itself to match a circuit to the line impedance. In the present invention the autotransformer concept is elaborated to make a device to connect into an existing telephone circuit to correct an impedance mismatch between two pieces of telephone equipment or between a piece of telephone equipment and a telephone line. The transformer used in the invention is, technically, not an autotransformer.

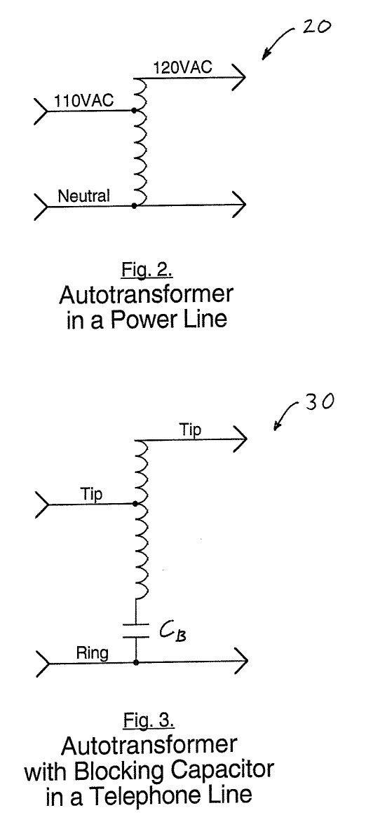

The autotransformer 20 of FIG. 2 could be connected into a telephone line to transform the impedance. However, two problems will occur: 1) it would short out the loop current and 2) it would imbalance the line. As shown in FIG. 3, the first problem is eliminated by adding a blocking capacitor C_{B} with the caveat that it creates a ring load (when the telephone line is ringing). However, the second problem of an imbalanced line still exists.

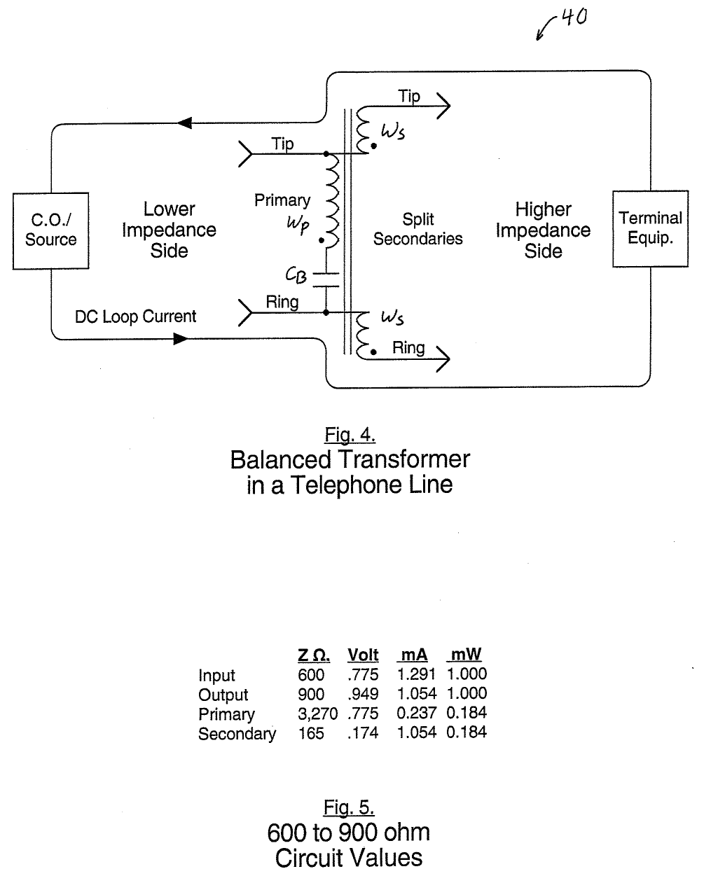

Referring to FIG. 4, a circuit 40 that connects into a telephone line to correct an impedance mismatch between two pieces of equipment is shown. The circuit 40 corrects the problems associated with the autotransformer 30 of FIG. 3 by balancing the line. As stated above, the shorting issue is eliminated by adding a blocking capacitor C_{B} with the caveat that it creates a ring load (when the telephone line is ringing). The issue of the imbalance line is eliminated by separating half of the extended winding into a separate secondary winding W_{S}, as shown in FIG. 4. This restores the line balance, a necessary step to prevent crosstalk and susceptibility to interference between telephone lines.

Like an autotransformer, the circuit 40 is very efficient because only a small portion of the signal is actually transformed. In this circuit 40, when designed to transform 600 ohms to 900 ohms, only 18.4% of the signal power is driven into the primary W_{P} and out of the two secondaries Wₛ of the transformer. This is because the secondary voltage is added to the 600 ohm input signal voltage. Only the difference in voltage is transformed. Even with an inefficient transformer, the overall efficiency of the circuit 40 is quite high. For example, a 70% efficient transformer will still provide 94.5% overall circuit efficiency in the example. This provides the tight coupling necessary to provide accurate impedance conversion in both directions, thereby reducing or eliminating echo in both directions when the transformer is properly designed to match the impedances of the equipment it connects.

The loop current flows through both secondaries W_{S} in the same direction, which means that the transformer runs “wet,” with the DC loop current from the telephone line magnetizing the transformer in one direction.

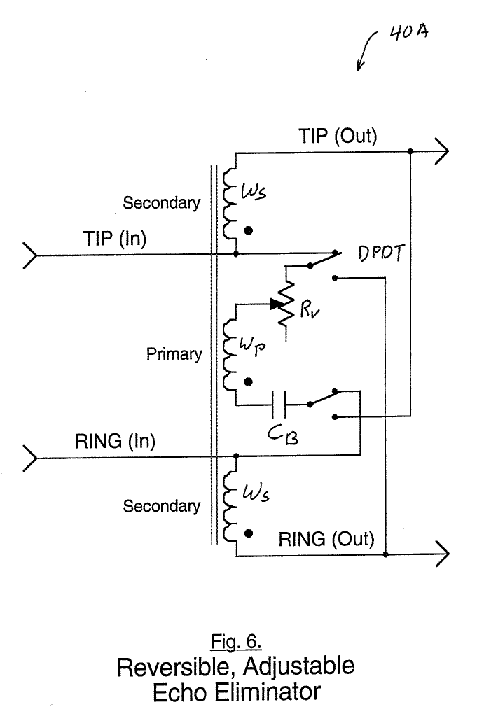

Referring to FIG. 5, a table shows the values for a 600 ohm to 900 ohm converter with a 1 mW signal going through it. The primary voltage roughly equals the input AC signal voltage. The difference between the input and output current is the primary current. The secondary AC signal current is the same as the output signal current and the secondary voltage is the difference between the input and output AC voltages. The power column shows the signal power and the small portion which passes through the transformer.

Referring to FIG. 6, another embodiment of the circuit 40A is shown. In this embodiment, the circuit 40A can be reversed to transform impedance down from the source equipment to the terminal equipment. A double-pole double-throw (DPDT) switch DPDT connects the primary W_{P} to either end of the secondary windings to allow the circuit to be reversed with a minimum of components. This allows the circuit 40A to transform impedances either up or down at the flip of the switch DPDT.

Impedance transformation is relative, which means that a 600 to 900 ohm converter will also convert 800 ohms to 1,200 ohms. The transformer provides a conversion ratio, in this example 1.5. This makes the circuits 40 and 40A very flexible to match impedances encountered in the real world where they are not exact. Because of the low percentage of power driven through the primary W_{P}, there is the opportunity to vary the impedance ratio somewhat to match actual impedances even more accurately to reduce echo to a minimum. The circuit 40A invention may optionally include a variable resistor R_{V} in series with the primary winding Wₚ to adjust the impedance ratio.

As the value of the resistor R_{V} increases, the impedance conversion ratio in the upward direction decreases and in the downward direction, increases. That reduces far-end echo at the cost of adding some near-end echo. As long as the near-end echo does not pass through digital delays it will only be heard as additional sidetone, and an imperceptible amount in most cases. The resistor value is ultimately limited to the primary winding impedance, it is primarily limited to a reasonable total circuit loss. In the example a 2,000 ohm resistor can vary the impedance ratio to 1.33 in one direction and 1.66 in the other direction. Restated, the circuit 40A can convert from 600 ohms up to 800-900 ohms or from 900-1,000 ohms down to 600 ohms. Even with this broader range, the insertion loss is less than 1 dB. At maximum setting, the resistor dissipates only 11.2% of the signal power in the example, or a 0.52 dB loss.

In the circuit 40A, the primary winding W_{P} of the transformer, the blocking capacitor C_{B} and optional variable resistor R_{V} may be connected in series in any order, but the “dot” end of the primary W_{P} must be connected toward the non-dot ends of the secondaries W_{S}. The Tip and Ring conductors may be reversed in the circuit 40A without affect.

Because of its simplicity, low cost, efficiency and not needing a power source, the circuit 40A provides an effective solution to echo problems on 2-wire analog telephone lines.

The circuit 40A will eliminate the echo that results from impedance mismatch. The circuit 40A is reversible and adjustable to match a wide range of impedance differences, to minimize or eliminate echo at its source on a telephone line. The circuit 40A performs the above functions efficiently and at a low cost, thereby eliminating the need to add expensive echo canceling devices after the fact. The circuit 40A does not require power. It is completely passive and exhibits very low insertion loss. It is compatible with all of the signaling that occurs on an analog telephone line.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A circuit that connects into a telephone line to correct an impedance mismatch between two pieces of equipment to eliminate an echo that results from the impedance mismatch comprising:
an autotransformer wherein a winding is separated into a primary and a pair of secondary windings; and
a capacitive element coupled to the primary winding.

2. A circuit that connects into a telephone line to correct an impedance mismatch in accordance with claim 1 wherein the capacitive element is coupled in series with the primary winding.

3. A circuit that connects into a telephone line to correct an impedance mismatch in accordance with claim 1 further comprising a switching element coupled to the primary winding and the secondary windings.

4. A circuit that connects into a telephone line to correct an impedance mismatch in accordance with claim 3 wherein the switching element is a double pole double throw switch to transform impedance bi-directionally between the two pieces of equipment.

5. A circuit that connects into a telephone line to correct an impedance mismatch in accordance with claim 3 further comprising a resistive element coupled to the primary winding.

6. A circuit that connects into a telephone line to correct an impedance mismatch in accordance with claim 3 further comprising a variable resistive element coupled in series to the primary winding.

7. A circuit that connects into a telephone line to correct an impedance mismatch in accordance with claim 3 further comprising a variable resistive element coupled in series to the primary winding to vary an impedance ratio for impedance matching.

8. A circuit that connects into a telephone line to correct an impedance mismatch in accordance with claim 6 wherein a dot end of the primary winding is coupled to a non-dot end of one of the secondary windings.

9. A circuit that connects into a telephone line to correct an impedance mismatch between two pieces of equipment to eliminate an echo that results from the impedance mismatch comprising:
an autotransformer wherein a winding is separated into a primary and a pair of secondary windings;
a capacitive element coupled in series to the primary winding; and
a switching element coupled to the primary winding and the secondary windings.

9. A circuit that connects into a telephone line to correct an impedance mismatch in accordance with claim 8 wherein the switching element is a double pole double throw switch to transform impedance bi-directionally between the two pieces of equipment.

10. A circuit that connects into a telephone line to correct an impedance mismatch in accordance with claim 8 further comprising a resistive element coupled in series to the primary winding.

11. A circuit that connects into a telephone line to correct an impedance mismatch in accordance with claim 8 further comprising a variable resistive element coupled in series to the primary winding.

12. A circuit that connects into a telephone line to correct an impedance mismatch in accordance with claim 8 further comprising a variable resistive element coupled in series to the primary winding to vary an impedance ratio for impedance matching.

13. A circuit that connects into a telephone line to correct an impedance mismatch in accordance with claim 8 wherein a dot end of the primary winding is coupled to a non-dot end of one of the secondary windings.

14. A circuit that connects into a telephone line to correct an impedance mismatch between two pieces of equipment to eliminate an echo that results from the impedance mismatch comprising:
an autotransformer wherein a winding is separated into a primary and a pair of secondary windings;
a capacitive element coupled in series to the primary winding;
a switching element coupled to the primary winding and the secondary windings; and
a variable resistive element coupled in series to the primary winding.

15. A circuit that connects into a telephone line to correct an impedance mismatch in accordance with claim 14 wherein the switching element is a double pole double throw switch to transform impedance bi-directionally between the two pieces of equipment.

16. A circuit that connects into a telephone line to correct an impedance mismatch in accordance with claim 14 wherein the variable resistive element coupled in series to the primary winding varies an impedance ratio for impedance matching.

17. A circuit that connects into a telephone line to correct an impedance mismatch in accordance with claim 14 wherein a dot end of the primary winding is coupled to a non-dot end of one of the secondary windings.
